(19) United States
(12) Patent Application Publication
(10) Pub. No.: US 2024/0367045 A1
(43) Pub. Date: Nov. 7, 2024

(54) METHOD FOR CONTROLLING VIRTUAL OBJECT

(71) Applicant: NETEASE (HANGZHOU) NETWORK CO., LTD., Hangzhou, Zhejiang (CN)

(72) Inventor: Yichen HAN, Hangzhou, Zhejiang (CN)

(73) Assignee: NETEASE (HANGZHOU) NETWORK CO., LTD., Hangzhou, Zhejiang (CN)

(21) Appl. No.: 18/291,601

(22) PCT Filed: Apr. 7, 2022
(86) PCT No.: PCT/CN2022/085655

§ 371 Date: Jan. 24, 2024

(30) Foreign Application Priority Data
Aug. 19, 2021 (CN) 202110955776.9

(51) Int. Cl. A63F 13/5372; A63F 13/52; A63F 13/822

(52) U.S. Cl. CPC A63F 13/5372; A63F 13/52; A63F 13/822

(57) ABSTRACT

A method for controlling a virtual object, including: determining, in response to a trigger instruction for a game skill of a first player character located in a game scene, a target virtual object corresponding to the trigger instruction, and controlling the target virtual object to monitor a monitoring area in the game scene so as to locate a second player character within the monitoring area; and, displaying calibration information of the second player character located in the graphical user interface, where the calibration information of the second player character comprises at least one of a character identification corresponding to the second player character or a position identification corresponding to the second player character.

### CROSS REFERENCE TO RELATED APPLICATIONS

The present application is a National Stage Application of International Application No. PCT/CN2022/085655 filed on Apr. 7, 2022 which is based upon and claims priority to Chinese Patent Application No. 202110955776.9 entitled “Method for controlling virtual object, and electronic device and readable medium”, filed on Aug. 19, 2021, the entire contents of both of which are incorporated herein by reference for all purposes.

### TECHNICAL FIELD

The present disclosure relates to the field of game technology, and in particular, to a method for controlling a virtual object, an electronic device, and a computer-readable medium.

### BACKGROUND

With the development of computer technology and game technology, games have become an important entertainment manner in people's daily life. Among them, in related confrontation games, at least two game camps are divided, and the player characters of different game camps have different identities, such as defensive party and offensive party. In a round of game the offensive party needs to obtain the corresponding game prop in the game scene or complete the specified game task to clear every level, and the defensive party needs to find the offensive party located in the game scene to prevent the offensive party from obtaining the corresponding game prop or completing the game task, etc.

It should be noted that the information disclosed in the above background part is only used to enhance the understanding of the background of the present disclosure, and therefore may include information that does not constitute related art known to those of ordinary skill in the art.

### SUMMARY

According to an aspect of the present disclosure, there is provided a method for controlling a virtual object: a graphical user interface is provided through a first electronic terminal, and contents displayed by the graphical user interface includes at least a part of a game scene and a first player character located in the game scene; among them, the game scene further includes a second player character in a different game camp from the first player character, the first player character is configured with a plurality of game skills, each game skill corresponds to a virtual object, and the method includes the following:
determining, in response to a trigger instruction for a game skill, a target virtual object corresponding to the trigger instruction, and controlling the target virtual object to monitor a set monitoring area in the game scene to locate the second player character within the monitoring area;
displaying calibration information of the second player character located in the graphical user interface, where the calibration information of the second player character comprises at least one of a character identification corresponding to the second player character or a position identification corresponding to the second player character.

It should be understood that the above general description and the following detailed description are exemplary and explanatory only and are not intended to limit the present disclosure.

### BRIEF DESCRIPTION OF THE DRAWINGS

In order to more clearly illustrate the technical solutions in the embodiments of the present disclosure, the accompanying drawings that need to be used in the description of the embodiments are briefly described below. Obviously, the drawings in the following description are some embodiments of the present disclosure, and for those of ordinary skill in the art, other drawings can also be obtained from these drawings without creative efforts.

FIG. 1 is a flowchart of a method for controlling a virtual object according to an embodiment of the present disclosure;

FIG. 2 is a schematic diagram of a first monitoring area provided in an embodiment of the present disclosure:

FIG. 3 is a schematic diagram of a virtual object provided in an embodiment of the present disclosure:

FIG. 4 is a schematic diagram of a game interface provided in an embodiment of the present disclosure:

FIG. 5 is a structural block diagram of an apparatus for controlling a virtual object according to an embodiment of the present disclosure:

FIG. 6 is a block diagram of an electronic device according to an embodiment of the present disclosure:

FIG. 7 is a schematic diagram of a computer-readable medium according to an embodiment of the present disclosure.

### DETAILED DESCRIPTION

In order to make the above objectives, features and advantages of the present disclosure more comprehensible, the present disclosure will be further described in detail below with reference to the accompanying drawings and specific embodiments.

The method for controlling a virtual object in the embodiments of the present disclosure may run on a local terminal device or a server. When the method for controlling a virtual object runs on the server, it may be a cloud game.

In some embodiments, the cloud game refers to a game manner based on cloud computing. In the running manner of the cloud game, the running body of the game program and the game screen presentation body are separated; the storage and running of the method for controlling the virtual object are completed on the cloud game server, and the role of the cloud game client is to receive and send data, and present the game screen. For example, the cloud game client can be a display device with a data transmission function close to the user side, such as a mobile terminal, a television, a computer, a palm computer, or the like. However, it is the cloud game server in the cloud to perform game data processing. When a game is performed, the player operates the cloud game client to send an operation instruction to the cloud game server, the cloud game server runs the game according to the operation instruction, encodes and compresses data such as the game screen, returns the game screen to the cloud game client through the network, and finally decodes and outputs the game screen through the cloud game client.

In some embodiments, the local terminal device stores a game program and is configured to present a game screen. The local terminal device is configured to interact with the player through a graphical user interface, that is, to conventionally download and install the game program through the electronic device and run it. The manner in which the local terminal device provides the graphical user interface to the player may include a variety of manners; for example, it may be rendered and displayed on a display screen of the terminal, or it may be provided to the player through holographic projection. For example, the local terminal device may include a display screen and a processor; the display screen is configured to present a graphical user interface; the graphical user interface includes a game screen; the processor is configured to run the game, generate the graphical user interface, and control the display of the graphical user interface on the display screen.

Among them, in the embodiments of the present disclosure, illustrative description is provided by taking that the local terminal device is an electronic terminal as an example. It can be understood that local terminal device may also be the above-mentioned cloud game client, which is not limited in the present disclosure.

As an example, in a sneaking confrontation game, sneaking can be combined with asymmetric competition. Chasing and escaping confrontation can be performed in different game scenes. For example, a round of game may be composed of two defensive parties and four offensive parties. The offensive party has the advantage of the number of people, needs to hide from the view of the offensive party and the guard NPC (non-player character) in the game scene, sneaks to the target position, and completes the specified task and successfully evacuate. The defensive party has a strong strength, can see through the disguise of the offensive party under the assistance of the guard NPC, and chase the sneaking party in the game scene. In this process, the defensive player may need to consume a long time to find the offensive party player in the game scene, resulting in a long time consuming for the round of game, increasing the processing overhead of the terminal, and reducing the game experience of the player.

According to embodiments of the present disclosure, there is provided a method for controlling a virtual object, an apparatus, an electronic device, and a computer-readable storage medium, so as to solve or partially solve the problems in the related art that the round of game takes too long time, the terminal processing overhead is large, and the game experience is poor, due to the fact that an enemy player character in a game cannot be effectively searched. In this regard, one of the core concepts in the embodiments of the present disclosure is that; a plurality of game skills may be configured for a first player character of a game camp as a defensive party, and each game skill may correspond to a virtual object; in the game process, the player may release the corresponding target virtual object through the game skill, monitor the set monitoring area through the target virtual object, and calibrate the second player character in the monitoring area; and then, the terminal may display the calibration information of the second player character calibrated in the graphical user interface, so as to search, monitor and calibrate the second player character in the game scene effectively through monitoring by the target virtual object. By displaying the calibration information in the game interface, the player can intuitively and quickly determine the orientation of the second player character, so as to make a reasonable game decision, thus reducing the time consuming of the round of game and reducing the overhead of the terminal.

Among them, the player character involved in the embodiments of the present disclosure may be a character for the game controlled by a player in the game; the first player character may be a character controlled by a first player to which the first electronic terminal belongs, which may be a defensive party in the game; the second player character may be a character controlled by a second player to which the second electronic terminal belongs, which may be an offensive party in the game. It may be understood that, with the change of the game type, the first player character and the second player character may be mutually converted, which is not limited in the present disclosure.

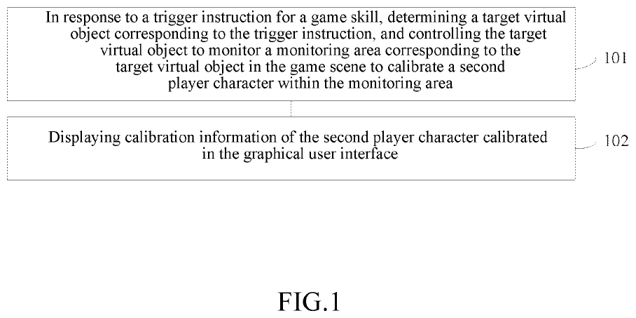

In some embodiments, referring to FIG. 1, it shows a flowchart of a method for controlling a virtual object according to an embodiment of the present disclosure. A graphical user interface is provided through a first electronic terminal, and the contents displayed by the graphical user interface include at least a part of a game scene and a first player character located in the game scene; where, the game scene further includes a second player character in a different game camp from the first player character, the first player character is configured with a plurality of game skills, each game skill corresponds to a virtual object, and the method may include the following steps.

In step 101, in response to a trigger instruction for the game skill, a target virtual object corresponding to the trigger instruction is determined, and the target virtual object is controlled to monitor a set monitoring area in the game scene to calibrate a second player character in the monitoring area.

In the embodiment of the present disclosure, for the first player character, its responsibility may be to prevent the second player character from completing a preset game task in the game, search for the second player character, chase the second player character, or the like. In this process, the player needs to know the position of the second player character in the game scene so as to control the first player character to perform the corresponding behavior. Therefore, determining the orientation of the second player character in the game scene is very important for the player, and is also a key to affect the duration of the round of game.

In some embodiments, for the first player character, a plurality of game skills may be configured for the first player character, for example, which may include a monitoring game skill, a searching game skill, an attacking game skill, or the like. The terminal may display a skill control corresponding to each game skill in the graphical interface, so that the first player touches the corresponding skill control to release the corresponding skill. Among them, the monitoring game skill may correspond to a monitoring virtual object; the searching game skill may correspond to a searching virtual object; and the attacking game skill may correspond to a close virtual object. In some embodiments, when the first player releases the monitoring skill, the terminal may place a monitoring virtual object in the game scene, the monitoring virtual object is configured with a first monitoring area, and the monitoring virtual object may monitor the first monitoring area. When the first player releases the searching game skill, the terminal may generate a searching virtual object in the game scene, and the searching virtual object may perform moving and searching in the game scene according to the searching path set by the player; the searching virtual object is configured with a second monitoring area, and may monitor the second monitoring area in the moving process. The attacking game skill may include an active attacking skill and a passive attacking skill. In the embodiments of the present disclosed, illustrative description is provided by taking that the attacking game skill is a passive game skill as an example. For the attacking game skill, when it is triggered, the close virtual object may attack the second player character. Therefore, by providing different types of game skills such as monitoring, searching, attacking or the like, the first player may release the corresponding virtual object to perform operations such as monitoring, searching, attacking or the like in the game scene in the game process, so that the first player may intuitively and quickly determine the orientation of the second player character of the enemy camp, so as to make a reasonable game decision, thus reducing the time consuming for the round of game, and reducing the overhead of the terminal.

In some embodiments, if the triggered game skill is a monitoring game skill, the terminal may generate a monitoring virtual object in the game scene in response to a trigger instruction for the monitoring game skill, display a first monitoring area corresponding to the monitoring virtual object, and then control the monitoring virtual object to monitor the first monitoring area so as to calibrate the second player character in the first monitoring area.

In the process that the first player places the monitoring virtual object through the monitoring game skill, the terminal may obtain skill information of the monitoring game skill in response to a trigger instruction for the monitoring game skill, then generate a monitoring virtual object in the game scene according to the skill information, and display a first monitoring area corresponding to the monitoring virtual object. In some embodiments, the skill information may include the skill state, the number of the monitoring virtual object placed, etc. After the player touches the skill control corresponding to the monitoring game skill, the terminal may firstly determine the skill state of the monitoring game skill. If the skill state of the monitoring game skill is in a ready state, the terminal may obtain the number of the monitoring virtual object placed in the game scene, generate a monitoring virtual object in the game scene in the condition that the number of the monitoring virtual object placed does not reach an upper limit, and display a first monitoring area corresponding to the monitoring virtual object. If the number of the monitoring virtual object placed reaches the upper limit, the terminal may output information for prompting that the monitoring virtual objects have reached the upper limit for placement. Then, the terminal may destroy the monitoring virtual object earliest placed by the first player in the game scene, place a new monitoring virtual object in the game scene, and display the first monitoring area corresponding to the monitoring virtual object. Alternatively, the terminal may respond to the destruction instruction for the monitoring virtual object, determine the target monitoring virtual object corresponding to the destruction instruction, destroy the target monitoring virtual object in the game scene, and then place a new monitoring virtual object in the game scene, and display the first monitoring area corresponding to the new monitoring virtual object. For example, the terminal may display, in the graphical user interface, information indicating that the placement of the monitoring virtual object has reached the upper limit, so as to prompt the user to destroy the monitoring virtual object earliest placed, or autonomously select a monitoring virtual object that the user wants to destroy. In some embodiments, the first player may view the position icon corresponding to the monitoring virtual object placed in the game map interface, and select a certain position icon. The terminal may output the corresponding “Destruction Questioning”, and destroy the monitoring virtual object selected by the first player in the game scene after the first player determines to destroy, and correspondingly place the new monitoring virtual object at the current position of the first player character.

In addition, if the skill state of the monitoring game skill is in a cooling state, prompt information for the monitoring game skill is output to prompt the player that the skill is in the cooling state and cannot be released. Moreover, after the first player successfully releases the monitoring game skill, the monitoring game skill enters the cooling state. After cooling of the skill is finished, the player can release the monitoring game skill again.

After the first player successfully places the monitoring virtual object in the game scene, the terminal may obtain the running state of the monitoring virtual object, and display the position icon corresponding to the running state of each monitoring virtual object in the game map, where different running states may correspond to different position icons. In some embodiments, the running states of a monitoring virtual object may include a working state and a restart state. The working state is a state in which the monitoring virtual object monitors a set first monitoring area. The restart state is a state in which the monitoring virtual object is restarted. If the monitoring virtual object is in a working state, a first position icon corresponding to the monitoring virtual object is displayed in a preset game map. If the monitoring virtual object is in a restart state, a second position icon corresponding to the monitoring virtual object is displayed in the game map. Among them, the first position icon and the second position icon may be icons of different display styles. For example, the first position icon may be a green dot, and the second position icon may be a red dot or the like, so that the running state of the monitoring virtual object is marked through different display colors, thus the first player can visually and quickly understand the running state of each monitoring virtual object, understand the change in the game scene, and then make a corresponding game decision.

In the game process, the first player can monitor the related area of the game scene through the monitoring virtual object. Meanwhile, the second player can control the second player character to destroy the monitoring virtual object, so as to prevent the monitoring virtual object from monitoring the related area, so that the players can perform game interaction through placing the monitoring virtual object, destroying the monitoring virtual object or the like, greatly improving the interactivity and interestingness of the game.

In some embodiments, if it is detected that the monitoring virtual object is attacked by the second player character and the attack of the second player character is destroyed, the terminal can control the monitoring virtual object to enter the restart state. Meanwhile, the terminal can switch the position icon corresponding to the destroyed monitoring virtual object from the first position icon to the second position icon, cancel the display of the first monitoring area corresponding to the monitoring virtual object, and output prompt information that the monitoring virtual object is destroyed in the graphical user interface of the first electronic terminal corresponding to the first player character, thus the player can be prompted that there is a monitoring virtual object destroyed through the prompt information, visually and quickly know which monitoring virtual object is destroyed through the change of the position icon, so that the first player controls the first player character to the corresponding position for viewing.

For the monitoring virtual object, when it is in a normal working state, the monitoring virtual object may monitor the first monitoring area corresponding to itself in real time. If a second player character in the target state is present in the first monitoring area, at least one of a calibration state or an index state can be added to the second player character in the target state. Among them, the calibration state may be a state in which the second player character is in a global orientation prompt in the game scene; for example, a red edge contour corresponding to the second player character is displayed on the graphical user interface, or, a position point of the second player character is displayed in the game map, so that the first player may quickly and intuitively perceive the orientation of the second player character in the game scene. The index state may be a state in which the second player character may be identified and attacked. In the case that the condition is satisfied, the first player character can be triggered to automatically attack the second player character in the index state. The target state includes at least one of a running movement state, a crouching state, a camouflage error state and a skill release state, where the camouflage error state can be that the virtual clothes currently worn by the second player character do not match the scene area corresponding to the game scene in which the second player character is located, or the like.

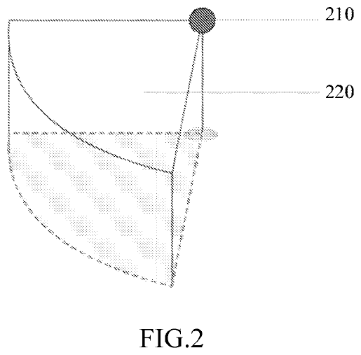

In an example, for the monitoring game skill, a skill control corresponding to the monitoring game skill may be displayed in the game interface, and the skill control may be displayed according to the skill state. For example, when the monitoring game skill is in the ready state, the skill control may be displayed normally. When the monitoring game skill is in the cooling state, the terminal may obtain the cooling time, and display the remaining cooling time in the skill control, so that the first player may intuitively understand the skill state of the game skill. When the monitoring game skill is in the ready state, the terminal may obtain the character orientation and the current position of the first player character in response to the touch operation for the skill control of the monitoring game skill, and then display the monitoring virtual object with the character orientation as the target orientation on the current position, and the first monitoring area corresponding to the target orientation. Referring to FIG. 2, it shows a schematic diagram of a first monitoring area provided in an embodiment of the present disclosure. The first monitoring area 220 corresponding to the monitoring virtual object 210 may be a fan-shaped columnar area or a circular columnar area corresponding to the orientation of the first player character. In some embodiments, for the monitoring virtual object, it may be a virtual object suspended in a fixed position in the game scene, such as an unmanned aerial vehicle, a virtual eyeball, a virtual observation tower, a virtual camera, etc., which is not limited in the present disclosure.

For the first monitoring area of the monitoring virtual object, the first monitoring area may be clearly visible relative to the first player character, and may be faintly visible relative to the second player character. Along with the bright change of the game scene light, the identification degree of the first monitoring area is also changed. For example, in a scene with relatively weak light, the identification degree is relatively high; and, in a scene with relatively strong light, the identification degree is relatively weak, etc.

In the process of monitoring the corresponding first monitoring area, the monitoring virtual object may add the calibration state and the index state to the second player character if the second player character in the target state (one of the running state, the crouching state, the camouflage error state and the skill release state) is present in the monitoring field of view with no physical obstruction, so that the terminal may perform position prompt on the second player character according to the calibration state, and may automatically attack the second player character in the index state when the first player character satisfies the condition. In some embodiments, for the added calibration state and the index state, they may be abnormal states of the player character, which may last for a certain duration, for example, may last for 3 seconds, etc. In addition, after adding a corresponding abnormal state to a certain second player character, the monitoring virtual object enters the cooling time, and triggers the duration needing to be refreshed again.

If the second player does not want the monitoring virtual object to monitor the corresponding area, it may control the second player character to destroy the monitoring virtual object, so that the monitoring virtual object cannot monitor the corresponding area. For example, the second player may control the second player character to be close to the monitoring virtual object for destruction, or control the second player character to throw corresponding virtual items to the monitoring virtual object for destruction. For a destroyed monitoring virtual object, it may enter the restart state, and cannot be destroyed again by the second player character during restart; for example, the restart duration is 60 seconds, and the second player character cannot destroy the monitoring virtual object again within 60 seconds, etc.

In addition, there is an upper limit for the number of the monitoring virtual object that can be placed in the game scene by the first player character. After the number for placement reaches the upper limit, the player can select to destroy the monitoring virtual object placed earliest, or select the monitoring virtual object that the player wants to destroy according to its own requirements, so that the first player can place the monitoring virtual object for monitoring in the game scene through the monitoring game skill. For example, the first player can place the monitoring virtual object in the key scene area in the game scene for monitoring, thus realizing search for the second player character through effectively monitoring at the corresponding monitoring area by the monitoring virtual object.

In some embodiments, if the triggered game skill is a searching game skill, the terminal may display a searching virtual object in the game scene in response to a trigger instruction for the searching game skill, determine a second monitoring area corresponding to the searching virtual object, and then control the searching virtual object to search for the second player character in the game scene so as to calibrate the second player character within the second monitoring area.

In the process that the first player releases the searching virtual object in the game scene through the searching game skill when the searching game skill is in the ready state, the terminal may display a game map interface in response to the trigger instruction for the searching game skill, then determine the searching destination of the searching virtual object in response to the touch operation for the game map interface, obtain the current position of the player character in the game scene, then determine the first target position corresponding to the current position in the game scene, display the searching virtual object at the first target position, determine the second monitoring area corresponding to the searching virtual object, and then control the searching virtual object to move from the first target position to the searching destination so as to calibrate the second player character within the second monitoring area. In some embodiments, the game map interface may be a map interface configured according to the game scene. When the game scene includes a multi-floor scene, and when the first player opens the game map interface, the game map interface may display a map interface of the floor where the first player character is currently located by default, and meanwhile, a corresponding tab is provided in the game map interface, so that the first player may control the game map interface to display the map interface of the other floor according to the tab, which is not limited in the present disclosure.

Among them, after the first player releases the searching game skill, the terminal may first determine whether the searching virtual object can reach the current position where the first player character is currently located. If the searching virtual object can reach the current position of the first player character, the terminal may display the searching virtual object at the current position. If the searching virtual object cannot reach the current position of the first player character, the terminal may determine a first target position corresponding to the current position, and display the searching virtual object at the first target position. In some embodiments, for the searching virtual object, it may be configured with a path-finding map corresponding to the game scene in the game. The path-finding map may be an area where the searching virtual object can reach and move. The terminal may select a position closest to the current position of the first player character as the first target position of the searching virtual object. i.e. the searching start point, so that the terminal displays the searching virtual object at the searching start point, and controls the searching virtual object to move from the searching start point to the searching destination. Moreover, the terminal may obtain the current position point corresponding to the first target position in the game map interface, and then display a searching path from the current position point to the destination in the game map interface, so that the first player knows the searching path of the searching virtual object in the game scene.

It should be noted that for the player character, the movable area for the player character in the game scene is larger than the movable area for the searching virtual object. For example, the game scene may include virtual items such as a virtual box body, a virtual table, a virtual cabinet, or the like, and the player may control the player character to move onto these virtual items. However, the searching virtual object cannot move onto these virtual items. Therefore, there is configured a path-finding map for the searching virtual object in the game, so that the terminal determines the position point of the searching virtual object.

In some embodiments, after the first player successfully releases the searching game skill to generate the searching virtual object in the game scene, the terminal can obtain the position information of the searching virtual object, display the movement identification corresponding to the searching virtual object in the game map interface displayed in the graphical user interface according to the position information, and send the position information to the second terminal device corresponding to the second player character. The second terminal device is used to display the movement identification corresponding to the searching virtual object in the game map interface displayed in the graphical user interface, so that the first player and the second player can know the position of the searching virtual object in the game scene through the real-time moving movement identification, then the first player can know the searching condition of the searching virtual object, and the second player can perform avoidance according to the position of the searching virtual object, thus improving the interestingness of the game.

For the game map interface, it may include a common path-finding point and a monitoring position point, where the monitoring position point may be a position point corresponding to the monitoring virtual object, and the common path-finding point may be any position point other than the monitoring position point in the game map interface. The first player may select the common path-finding point and/or the monitoring position point to set the searching path for the searching virtual object. Among them, in the process that the searching virtual object moves according to the searching path set by the first player, the terminal may control the searching virtual object to search for the second player character in the game scene, and add at least one of the calibration state or the index state to the second player character present in the second monitoring area, thus the searching virtual object may add the corresponding abnormal state to the second player character entering the second monitoring area along the way in the moving process, and the second player character in the game scene is effectively searched, so that the first player knows the orientation of the second player character in the game scene.

In one case, the terminal may determine, in response to a touch operation for any position point in the game map interface, the common path-finding point corresponding to the touch operation, take the position corresponding to the common path-finding point in the game scene as the searching destination of the searching virtual object, and then control the searching virtual object to move from the first target position to the position corresponding to the common path-finding point.

In another case, the terminal may, in response to a touch operation for a first monitoring position point, take the position corresponding to the first monitoring position point in the game scene as the transit position of the searching virtual object. Then, in response to a touch operation for a second monitoring position point, the terminal may take the position corresponding to the second monitoring position point in the game scene as the searching destination of the searching virtual object, and control the searching virtual object to move from the first target position to the position corresponding to the first monitoring position point, and then move from the position corresponding to the first monitoring position point to the position corresponding to the second monitoring position point.

In another case, the terminal may, in response to a touch operation for the first monitoring position point, take the position corresponding to the first monitoring position point as the transit position of the searching virtual object. Then, in response to a touch operation for any position point in the game map interface, the terminal may determine a common path-finding point corresponding to the touch operation, take the position corresponding to the common path-finding point as the searching destination of the searching virtual object, and then control the searching virtual object to move from the first target position to the position corresponding to the first monitoring position point, and then move from the position corresponding to the first monitoring position point to the position corresponding to the common path-finding point.

In another case, the terminal may, in response to a touch operation for the target monitoring position point, take the position corresponding to the target monitoring position point in the game scene as the searching destination of the searching virtual object, and then control the searching virtual object to move from the first target position to the position corresponding to the target monitoring position point.

In addition, when the searching virtual object is about to reach the searching destination, if the searching destination is the position corresponding to the monitoring position point and the monitoring virtual object cannot reach the position corresponding to the monitoring position point (for example, the first player places the monitoring virtual object on some virtual items), the terminal may first determine a second target position closet to the position corresponding to the monitoring position point, then control the monitoring virtual object to instantaneously move to the position corresponding to the monitoring position point in response to the monitoring virtual object moving to the second target position, so that the searching virtual object can accurately move to the searching destination set by the first player by flexibly adjusting the movement manner of the searching virtual object, thus ensuring the searching effect of the searching virtual object.

In the embodiment of the present disclosure, the searching virtual object and the monitoring virtual object may be mutually reinforced. When the first monitoring area of the monitoring virtual object overlaps with the second monitoring area of the searching virtual object, the corresponding monitoring virtual object may be switched to the monitoring reinforcement state. Within the duration of the monitoring reinforcement state, any second player character entering the first monitoring area of the monitoring virtual object may be directly added with the calibration state and the index state, without determining whether the second player character is in the target state. When the searching destination of the searching virtual object is the monitoring position point corresponding to the monitoring virtual object, the reinforcement of the searching virtual object may be triggered when the searching virtual object arrives at the monitoring position point, increasing the range of the second monitoring area of the searching virtual object, so that the searching virtual object can search within a larger range, thus enriching the interestingness of the game through the linkage between the searching virtual object and the monitoring virtual object, improving the searching capability of the player character, and ensuring the searching effect.

In some embodiments, in the process that the searching virtual object searches and moves in the game scene, the terminal may control the searching virtual object to move from the first target position to the searching destination with the second monitoring area as the scanning range, so as to calibrate the second player character within the scanning range. Or, the terminal may also control the searching virtual object to move from the first target position to the searching destination at a preset movement speed and with the second monitoring area as the scanning range, so as to calibrate the second player character within the scanning range. Moreover, in the process that the searching virtual object searches in the game scene, if the first monitoring area of the monitoring virtual object overlaps with the second monitoring area of the searching virtual object, the monitoring virtual object is switched to the monitoring reinforcement state. Within the duration of the monitoring reinforcement state of the monitoring virtual object, the terminal may add at least one of the calibration state or the index state to the second player character present in the first monitoring area.

In addition, if the searching virtual object arrives at the searching destination and the searching destination is the position corresponding to the monitoring position point, the terminal may switch the monitoring virtual object to the monitoring reinforcement state in response to the first monitoring area of the monitoring virtual object overlapping with the second monitoring area of the searching virtual object, and add at least one of the calibration state or the index state to the second player character present in the first monitoring area within the duration of the monitoring reinforcement state of the monitoring virtual object. Meanwhile, the terminal may increase the second monitoring area of the searching virtual object, and control the searching virtual object to destruct after staying on the monitoring virtual object corresponding to the monitoring position point for a preset duration. If the searching virtual object arrives at the searching destination and the searching destination is the position corresponding to the common path-finding point, the terminal may control the searching virtual object to destruct after staying at the searching destination for a preset duration.

In some embodiments, there is a reinforcement effect between the searching virtual object and the monitoring virtual object. For the monitoring virtual object, when the first monitoring area of the monitoring virtual object overlaps with the second monitoring area of the searching virtual object, the monitoring reinforcement of the monitoring virtual object may be triggered, so that the monitoring virtual object enters the monitoring reinforcement state. The monitoring virtual object in the monitoring reinforcement state can directly add at least one of the calibration state or the index state to the second player character present in the first monitoring area, and the second player character does not need to be in the target state. For the searching virtual object, if the searching destination of the searching virtual object is the position corresponding to the monitoring position point, that is, when the searching virtual object moves to the monitoring virtual object corresponding to the monitoring position point, the range of the second monitoring area of the searching virtual object may be increased, so as to improve the searching capability of the searching virtual object, thus improving the searching efficiency for the second player character in the game scene through the linkage between the searching virtual object and the monitoring virtual object.

In some embodiments, in the foregoing cases, if the monitoring virtual object is in the restart state, state switching is not performed on the monitoring virtual object. For example, when the second monitoring area of the searching virtual object covers the monitoring virtual object, and the monitoring virtual object is in the restart state, at this time, state switching is not performed on the monitoring virtual object, and the restart state of the monitoring virtual object is maintained.

In an example, for the searching game skill, the skill control corresponding to the searching game skill may be displayed in the game interface, and the skill control may be displayed according to the skill state. For example, when the searching game skill is in the ready state, the skill control may be displayed normally. When the searching game skill is in the cooling state, the terminal may obtain the cooling time, and display the remaining cooling time in the skill control, so that the first player intuitively knows the skill state of the game skill. When the searching game skill is in the ready state, the terminal may display the game map interface for the touch operation of the skill control for the searching game skill correspondingly, then determine the searching destination of the searching virtual object according to the point selection operation of the first player in the game map interface, and display the corresponding searching path. After the searching virtual object is successfully released, the movement identification corresponding to the searching virtual object may be displayed on the game map interface displayed in the first electronic terminal corresponding to the first player, and the movement identification of the searching virtual object may be displayed on the game map interface displayed in the second electronic terminal corresponding to the second player, so that the first player and the second player can know the position of the searching virtual object in the game scene through the real-time moving movement identification, the first player can know the search condition of the searching virtual object, and the second player can perform avoidance according to the position of the searching virtual object, etc., thus improving the interestingness of the game.

When the searching virtual object is searching and moving, the searching virtual object may scan along the way at a preset movement speed and with a certain scanning radius. For example, the searching virtual object may move to the searching destination at a speed of 7.5 meters per second at the search starting point in the game scene, and may search with a scanning radius of 5 meters in the moving process. In the moving process of the searching virtual object, the searching virtual object passes the monitoring virtual object along the way, and the scanning range overlaps with the monitoring area of the monitoring virtual object, then the monitoring virtual object can be triggered to enter the monitoring reinforcement state, so that the monitoring virtual object can directly add the calibration state and the index state to the second player character present in the monitoring area, and the second player character does not need to be in the target state.

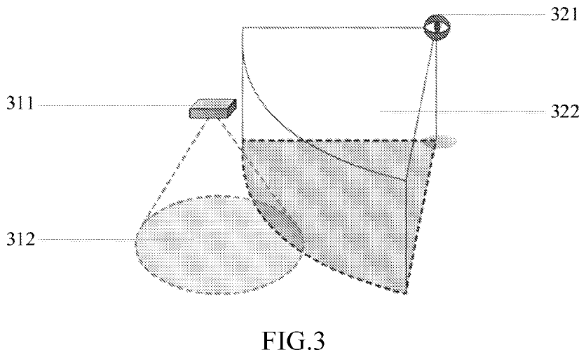

When the searching virtual object moves to the searching destination, if the searching destination is only a common path-finding point, the searching virtual object may disappear after staying at the position corresponding to the common path-finding point for 10 seconds. If the searching destination is the monitoring position point, the searching virtual object may increase the scanning range to 8 meters within 1 second after arriving, and then disappear after staying on the monitoring virtual object corresponding to the monitoring position point for 10 seconds. Meanwhile, before the searching virtual object disappears, if the scanning range of the searching virtual object overlaps with the monitoring area of the monitoring virtual object, the monitoring virtual object may be triggered to enter the monitoring reinforcement state. It can be understood that, for the monitoring virtual object in the restart state, although the searching virtual object cannot perform monitoring reinforcement on the monitoring virtual object, the searching virtual object may take the monitoring position point corresponding to the monitoring virtual object as a transit point or a searching destination. Referring to FIG. 3, it shows a schematic diagram of a virtual object provided in an embodiment of the present disclosure, in which, when the scanning range 312 of the searching virtual object 311 overlaps with the monitoring area 322 of the monitoring virtual object 321, the monitoring virtual object 321 may be triggered to enter the monitoring reinforcement state, so that the monitoring virtual object 321 may directly add the calibration state and the index state to the second player character present in the monitoring area, and the second player character does not need to be in the target state.

In some embodiments, the searching virtual object may be a virtual object that can move in suspension in the game scene, such as an unmanned aerial vehicle, a scanning messenger, a flying robot, a virtual flying insect, etc. The searching virtual object may move according to at least two levels of preset suspension heights in the game scene. When encountering an obstacle that cannot be passed during the moving process, the searching virtual object may pass through adjusting the suspension height. When going upstairs, the searching virtual object may always maintain the current suspension height for moving, etc., which is not limited in the present disclosure.

In step 102, calibration information of the calibrated second player character is displayed in the graphical user interface.

In some embodiments, for the second player character calibrated by the monitored virtual object and/or the searching virtual object in the game scene, the terminal may display the character identification corresponding to the second player character in the calibration state in the game scene, and/or display the position identification corresponding to the second player character in the calibration state in the preset game map. For example, for the second player character in the calibration state, the terminal may display the perspective contour (i.e., the character identification) corresponding to the second player character in the graphical user interface, so that the first player may know the range corresponding to the second player character through the perspective contour, and may also display the position identification corresponding to the second player character in the game map, both of which last for a certain period of time. On one hand, it is ensured that the first player can effectively perceive the position of the second player character; on the other hand, the fairness of the game is maintained, and the game experience of the second player is ensured.

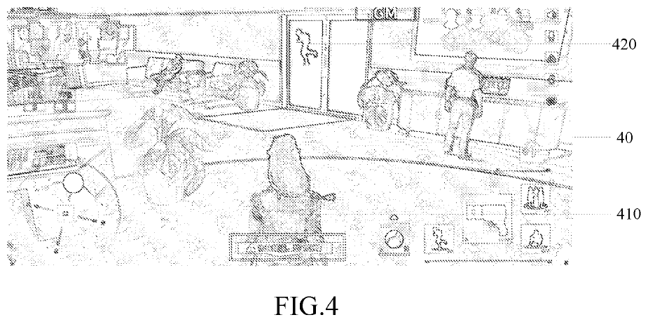

Referring to FIG. 4, it shows a schematic diagram of a game interface provided in an embodiment of the present disclosure. A graphical user interface is provided through an electronic terminal, the content displayed in the graphical user interface includes a game interface 40, and the game interface 40 includes a first player character 410. After the monitoring virtual object placed and/or the searching virtual object released in the game scene by the first player add a calibration state to a second player character of the enemy game camp, the terminal may display the perspective contour 420 of the second player character calibrated in the graphical user interface, so that the first player may know the range corresponding to the second player character through the perspective contour 420, and may further display a position identification (not shown) corresponding to the second player character in the game map, thus the first player may make a corresponding game decision.

In some embodiments, the game skill of the first player character may further include an attacking game skill. The attacking game skill may correspond to a close virtual object. The close virtual object may be permanently displayed within a preset range of the first player character (for example, it may move within a radius range of 0.5 meter of the first player character), and may be correspondingly displayed according to the skill state of the attacking game skill. For example, if the attacking game skill is in the ready state, the close virtual object may emit a certain amount of light. If the attacking game skill is in the cooling state, the close virtual object is not bright, etc.

In some embodiments, the terminal may determine the second player character in response to a trigger instruction for the attacking game skill, and control the close virtual object to perform an attacking operation for the second player character. In one case, if the second player character is present within the target range of the first player character, the attacking game skill can be triggered, and then the close virtual object is controlled to perform the attacking operation for the second player character. That is, attack is triggered when the second player character is present within the target range of the first player character. In another case, the terminal may trigger the attacking game skill in response to detecting that the second player character in the index state and/or the second player character in the calibration state are present within the target range of the first player character, and then control the close virtual object to perform an attacking operation for the second player character. That is, attack is triggered when the second player character in a specific state is present within the target range of the first player character.

In some embodiments, for the latter, the terminal may first obtain a relative distance between the first player character and the second player character located in the game scene, and determine the second player character in the index state and/or the calibration state in the game scene, and then trigger the attacking game skill if the relative distance between the first player character and the second player character in the index state and/or the second player character in the calibration state is less than or equal to a preset distance threshold, and then control the close virtual object to perform an attacking operation for the second player character. Therefore, in the game, the player may add the index state and/or the calibration state to the second player character through the monitoring virtual object and the searching virtual object. Meanwhile, in the case that the condition is satisfied, the player may trigger the close virtual object to automatically attack this kind of second player character, realizing the linkage among the plurality of game skills and the plurality of virtual objects, and greatly improving the playability and interestingness of the game. At the same time, the searching effectiveness for the player character of the enemy camp is effectively improved through multi-dimensional linkage, so that the first player can make a targeted game decision according to the searching result, reducing the game duration of the round of game, and reducing the performance overhead of the terminal.

Furthermore, considering that there is a rich variety of virtual items in the game scene, which may easily form the physical obstacles between the first player character and the second player character, when there is an obstacle between the first player character and the second player character in the index state and/or the calibration state, the second player character cannot be attacked. When there is no obstacle between the first player character and the second player character in the index state and/or the calibration state, the attacking game skill is triggered, and then the close virtual object is controlled to performed an attacking operation for the second player character. After a successful attack, the attacking game skill is switched to the cooling state.

In an example, the terminal may obtain a relative distance between the first player character and each second player character in the game scene. When the relative distance between the first player character and the second player character is less than or equal to 30 meters, it may be detected whether the second player character is in the index state and/or the calibration state. If the second player character is in the index state and/or the calibration state, the terminal may obtain the skill state of the attacking game skill of the first player character; and if the skill state is the ready state, the terminal may control the close virtual object to attack the second player character in the condition that there is no physical blocking between the first player character and the second player character. This attack belongs to an attack that must be hit; and after the hit, an abnormal state is added to the second player character. For example, one of the deceleration state for a preset duration, the paralysis state for a preset duration, the blood-drop state for a preset duration, and the falling-to-ground state for a preset duration is added.

In addition, when there is a plurality of second player characters satisfying the attack, in one case, the terminal may obtain the relative distance between each second player character and the first player character in the game scene, then take the second player character corresponding to the minimum relative distance as the target player character, and control the close virtual object to perform an attacking operation for the target player character. In another case, the terminal may obtain the blood volume value of each second player character, take the second player character corresponding to the minimum blood volume value as the target player character, and control the close virtual object to perform an attacking operation for the target player character. Therefore, the terminal can flexibly adjust the attack manner of the close virtual object according to the state of the second player character, thus ensuring the attack effectiveness of the close virtual object. It can be understood that, for the attack manner of the close virtual object, the first player may also perform self-defined setting according to its own requirements, which is not limited in the present disclosure.

In addition, the close virtual object may be an unmanned aerial vehicle, a virtual flying robot, a virtual flying insect, a guided pulse, etc., which is not limited in this disclosure.

It should be noted that the embodiments of the present disclosure are illustrated described by taking detection and control of the terminal on the monitoring virtual object, the searching virtual object and the close virtual object in the game scene as an example. It can be understood that the detection for these searching objects may also be that the server detects the game globally, and when it is detected that the state satisfies the corresponding condition, controls the corresponding virtual object to perform a corresponding operation, and notifies the electronic terminal corresponding to each player character in the round of game. It may also be that the server sends a control instruction to the electronic terminal, and the electronic terminal controls the corresponding virtual object according to the control instruction, etc. In addition, the embodiments of the present disclosure include, but are not limited to, the numerical parameters in the above examples. It can be understood that under the guidance of the concept of the embodiments of the present disclosure, those skilled in the art may further set the foregoing content according to actual requirements, which is not limited in the present disclosure.

In the embodiments of the present disclosure, a graphical user interface is provided through an electronic terminal; the graphical user interface may include a game scene, a first player character located in the game scene, and a second player character in a different game camp from the first player character; among them, the first player character is configured with a plurality of game skills, and each game skill corresponds to a virtual object; in the game process, the player may release the corresponding target virtual object through the game skill, monitor the set monitoring area through the target virtual object, and calibrate the second player character in the monitoring area; and then, the terminal may display the calibration information of the second player character calibrated in the graphical user interface, so as to search, monitor, and calibrate the second player character in the game scene effectively through monitoring by the target virtual object. By displaying the calibration information in the game interface, the player can intuitively and quickly determine the orientation of the second player character, so as to make a reasonable game decision, thus reducing the time consuming of the round of game and reducing the overhead of the terminal.

It should be noted that, for the method embodiments, they are all expressed as a series of action combinations for simplicity of description. However, those skilled in the art should understand that the embodiments of the present disclosure are not limited by the described action sequence, because some steps may be performed in other sequences or simultaneously according to the embodiments of the present disclosure. Secondly, those skilled in the art should also know that the embodiments described in the specification are all preferred embodiments, and the involved actions are not necessarily required by the embodiments of the present disclosure.

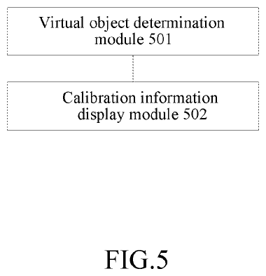

Referring to FIG. 5, it shows a structural block diagram of an apparatus for controlling a virtual object according to an embodiment of the present disclosure. A graphical user interface is provided through a first electronic terminal, and the contents displayed by the graphical user interface include at least a part of a game scene and a first player character located in the game scene; where, the game scene further includes a second player character in a different game camp from the first player character, the first player character is configured with a plurality of game skills, and each game skill corresponds to a virtual object, and the apparatus may include the following modules: a virtual object determination module 501 and a calibration information display module 502.

The virtual object determination module 501 is configured to perform determining, in response to a trigger instruction for the game skill, a target virtual object corresponding to the trigger instruction, and controlling the target virtual object to monitor a set monitoring area in the game scene so as to calibrate the second player character within the monitoring area.

The calibration information display module 502 is configured to perform displaying calibration information of the second player character calibrated in the graphical user interface.

In some embodiments, the game skill includes a monitoring game skill, and the monitoring game skill corresponds to a monitoring virtual object. The virtual object determination module 501 includes a monitoring virtual object determination sub-module and a monitoring area monitoring sub-module.

The monitoring virtual object determination sub-module is configured to perform generating a monitoring virtual object in the game scene in response to a trigger instruction for the monitoring game skill, and displaying a first monitoring area corresponding to the monitoring virtual object.

The monitoring area monitoring sub-module is configured to perform controlling the monitoring virtual object to monitor the first monitoring area so as to calibrate the second player character within the first monitoring area.

In some embodiments, the monitoring area monitoring sub-module is configured to perform:
controlling the monitoring virtual object to monitor the first monitoring area; if there is a second player character in a target state in the first monitoring area, adding at least one of a calibration state or an index state to the second player character in the target state, where the index state is a state in which the second player character is able to be identified and attacked;
where, the calibration information display module 502 is configured to perform;
if a second player character in the calibration state is detected, displaying a character identification corresponding to the second player character in the calibration state in the game scene, and/or, displaying a position identification corresponding to the second player character in the calibration state in a preset game map.

In some embodiments, the target state includes at least one of a running movement state, a crouching state, a camouflage error state, or a skill release state.

In some embodiments, the monitoring virtual object determination sub-module includes a skill information obtaining unit and a monitoring area display unit.

The skill information obtaining unit is configured to perform obtaining skill information of the monitoring game skill in response to the trigger instruction for the monitoring game skill.

The monitoring area display unit is configured to perform generating the monitoring virtual object in the game scene according to the skill information, and displaying the first monitoring area corresponding to the monitoring virtual object.

In some embodiments, the skill information includes a skill state, and the monitoring area display unit is configured to perform:
if the skill state of the monitoring game skill is a ready state, generating the monitoring virtual object in the game scene and displaying the first monitoring area corresponding to the monitoring virtual object.

In some embodiments, the skill information includes the number of the monitoring virtual object placed, and the monitoring area display unit is configured to perform:
if the number of the monitoring virtual object placed does not reach an upper limit, generating the monitoring virtual object in the game scene and displaying the first monitoring area corresponding to the monitoring virtual object.

In some embodiments, the monitoring area display unit is configured to perform:
obtaining a character orientation and a current position of the first player character;
displaying, on the current position, a monitoring virtual object with the character orientation as a target orientation, and a first monitoring area corresponding to the target orientation.

In some embodiments, the game skill further includes a searching game skill, the searching game skill corresponds to a searching virtual object, and the virtual object determination module 501 includes a searching virtual object determination sub-module and a player character searching sub-module.

The searching virtual object determination sub-module is configured to perform, in response to a trigger instruction for the searching game skill, displaying a searching virtual object in the game scene and determining a second monitoring area corresponding to the searching virtual object.

The player character searching sub-module is configured to perform controlling the searching virtual object to search for the second player character in the game scene so as to calibrate the second player character within the second monitoring area.

In some embodiments, the player character searching sub-module is configured to perform:
controlling the searching virtual object to search for the second player character in the game scene, and adding at least one of a calibration state or an index state to a second player character present in the second monitoring area, where the index state is used for performing an attack index on a second player character in the index state.

Among them, the calibration information display module 502 is configured to perform:
if a second player character in the calibration state is detected, displaying a character identification corresponding to the second player character in the calibration state in the game scene, and/or, displaying a position identification corresponding to the second player character in the calibration state in a preset game map.

In some embodiments, the searching virtual object determination sub-module includes a game map interface display unit, a searching destination determination unit, a current position obtaining unit, and a second monitoring area determination unit.

The game map interface display unit is configured to perform displaying a game map interface in response to the trigger instruction for the searching game skill.

The searching destination determination unit is configured to perform determining a searching destination of the searching virtual object in response to a touch operation for the game map interface.

The current position obtaining unit is configured to perform obtaining a current position of the player character.

The second monitoring area determination unit is configured to perform determining a first target position corresponding to the current position in the game scene, displaying the searching virtual object at the first target position, and determining the second monitoring area corresponding to the searching virtual object.

Among them, the player character searching sub-module is configured to perform:
controlling the searching virtual object to move from the first target position to the searching destination so as to calibrate the second player character within the second monitoring area.

In some embodiments, the searching destination determination unit is configured to perform:
in response to a touch operation for any position point of the game map interface, determining a common path-finding point corresponding to the touch operation, and taking a position corresponding to the common path-finding point in the game scene as the searching destination of the searching virtual object.

In some embodiments, the game map interface includes a monitoring position point associated with the monitoring virtual object, and the searching destination determination unit is configured to perform:
in response to a touch operation for at least one monitoring position point, determining the searching destination of the searching virtual object.

In some embodiments, the searching destination determination unit is configured to perform:
in response to a touch operation for a first monitoring position point, taking a position corresponding to the first monitoring position point in the game scene as a transit position of the searching virtual object;
in response to a touch operation for a second monitoring position point, taking a position corresponding to the second monitoring position point in the game scene as the searching destination of the searching virtual object.

In some embodiments, the searching destination determination unit is configured to perform:
in response to a touch operation for the first monitoring position point, taking a position of the game scene corresponding to the first monitoring position point as a transit position of the searching virtual object;
in response to a touch operation for any position point of the game map interface, determining a common path-finding point corresponding to the touch operation, and taking a position corresponding to the common path-finding point in the game scene as the searching destination of the searching virtual object.

In some embodiments, the searching destination determination unit is configured to perform:
in response to a touch operation for a target monitoring position point, taking a position corresponding to the target monitoring position point in the game scene as the searching destination of the searching virtual object.

In some embodiments, the player character searching sub-module is configured to perform:
controlling the searching virtual object to move from the first target position to the transit position, and then move from the transit position to the searching destination so as to calibrate the second player character within the second monitoring area.

In some embodiments, the player character searching sub-module is configured to perform:
controlling the searching virtual object to move from the first target position to the searching destination with the second monitoring area as a scanning range, so as to calibrate the second player character within the scanning range;
or, controlling the searching virtual object to move from the first target position to the searching destination at a preset movement speed and with the second monitoring area as a scanning range, so as to calibrate the second player character within the scanning range.

In some embodiments, the apparatus further includes a first state switching module and a first player character processing module.

The first state switching module is configured to perform, if the searching virtual object arrives at the searching destination and the searching destination is a position corresponding to the monitoring position point, switching the monitoring virtual object to a monitoring reinforcement state in response to the first monitoring area of the monitoring virtual object overlapping with the second monitoring area of the searching virtual object.

The first player character processing module is configured to perform adding at least one of a calibration state or an index state to a second player character present in the first monitoring area within a duration of the monitoring reinforcement state of the monitoring virtual object.

In some embodiments, the apparatus further includes a virtual object reinforcement module.

The virtual object reinforcement module is configured to perform, if the searching virtual object arrives at the searching destination and the searching destination is a position corresponding to the monitoring position point, increasing the second monitoring area of the searching virtual object, and controlling the searching virtual object to destruct after staying on the monitoring virtual object corresponding to the monitoring position point for a preset duration.

In some embodiments, the apparatus further includes a virtual object processing module.

The virtual object processing module is configured to perform, if the searching virtual object arrives at the searching destination and the searching destination is a position corresponding to a common path-finding point, controlling the searching virtual object to destruct after staying at the searching destination for a preset duration.

In some embodiments, the apparatus further includes a second state reinforcement module and a second player character processing module.

The second state reinforcement module is configured to perform, in a process of searching in the game scene by the searching virtual object, switching the monitoring virtual object to a monitoring reinforcement state if the first monitoring area of the monitoring virtual object overlaps with the second monitoring area of the searching virtual object.

The second player character processing module is configured to perform adding at least one of a calibration state or an index state to a second player character present in the first monitoring area within a duration of the monitoring reinforcement state of the monitoring virtual object.

In some embodiments, the apparatus further includes a first movement identification display module and a second movement identification display module.

The first movement identification display module is configured to perform obtaining position information of the searching virtual object, and displaying a movement identification corresponding to the searching virtual object in a game map interface displayed on the graphical user interface according to the position information.

The second movement identification display module is configured to perform sending the position information to a second terminal device corresponding to the second player character, where the second terminal device is configured to display the movement identification corresponding to the searching virtual object in the game map interface displayed on the graphical user interface.

In some embodiments, the game skill includes an attacking game skill, the attacking game skill corresponds to a close virtual object, and the apparatus further includes a skill trigger module.

The skill triggering module is configured to perform, in response to a trigger instruction for the attacking game skill, determining a second player character, and controlling the close virtual object to perform an attacking operation for the second player character.

In some embodiments, the skill triggering module includes a skill triggering sub-module and an attacking operation execution module.

The skill triggering sub-module is configured to perform, if a second player character is present within a target range of the first player character, triggering the attacking game skill.

The attacking operation execution module is configured to perform controlling the close virtual object to perform the attacking operation for the second player character.

In some embodiments, the skill triggering sub-module is configured to perform:
in response to detecting that a second player character in the index state and/or the calibration state is present within the target range of the first player character, triggering the attacking game skill.

In some embodiments, the apparatus further includes a relative distance obtaining module.

The relative distance obtaining module is configured to perform obtaining a relative distance between the first player character and a second player character located in the game scene.

Among them, the skill triggering sub-module is configured to perform:
determining a second player character in the index state in the game scene;
if the relative distance between the first player character and the second player character in the index state and/or the second player character in the calibration state is less than or equal to a preset distance threshold, triggering the attacking game skill.

In some embodiments, the skill triggering sub-module is configured to perform:
if the relative distance between the first player character and the second player character in the index state and/or the second player character in the calibration state is less than or equal to a preset distance threshold, and no obstacle is present between the first player character and the second player character in the index state, triggering the attacking game skill.

For the apparatus embodiments, since they are basically similar to the method embodiments, the description is relatively simple, and the relevant parts may refer to the parts of the description of the method embodiments.

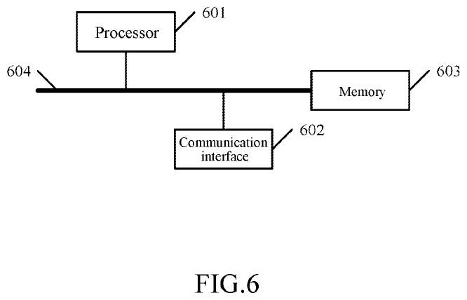

In addition, according to an embodiment of the present disclosure, there is further provided an electronic device. As shown in FIG. 6, the electronic device includes a processor 601, a communication interface 602, a memory 603, and a communication bus 604; where the processor 601, the communication interface 602, and the memory 603 communicate with each other through the communication bus 604.

The memory 603 is configured to store a computer program.

The processor 601 is configured to, when executing the program stored in the memory 603, implement the following steps:
in response to a trigger instruction for the game skill, determining a target virtual object corresponding to the trigger instruction, and controlling the target virtual object to monitor a set monitoring area in the game scene so as to calibrate the second player character within the monitoring area;
displaying calibration information of the second player character calibrated in the graphical user interface.

In some embodiments, the game skill includes a monitoring game skill, the monitoring game skill corresponds to a monitoring virtual object, and, in response to a trigger instruction for the game skill, determining a target virtual object corresponding to the trigger instruction, and controlling the target virtual object to monitor a set monitoring area in the game scene so as to calibrate the second player character within the monitoring area, includes:
in response to a trigger instruction for the monitoring game skill, generating a monitoring virtual object in the game scene, and displaying a first monitoring area corresponding to the monitoring virtual object;
controlling the monitoring virtual object to monitor the first monitoring area so as to calibrate the second player character within the first monitoring area.

In some embodiments, controlling the monitoring virtual object to monitor the first monitoring area so as to calibrate the second player character within the first monitoring area includes:
controlling the monitoring virtual object to monitor the first monitoring area; if a second player character in the target state is present in the first monitoring area, adding at least one of a calibration state or an index state to the second player character in the target state, where the index state is a state in which the second player character is able to be identified and attacked.

Among them, displaying calibration information of the second player character calibrated in the graphical user interface includes:
if a second player character in the calibration state is detected, displaying a character identification corresponding to the second player character in the calibration state in the game scene, and/or, displaying a position identification corresponding to the second player character in the calibration state in a preset game map.

In some embodiments, the target state includes at least one of a running movement state, a crouching state, a camouflage error state, and a skill release state.

In some embodiments, in response to a trigger instruction for the monitoring game skill, generating a monitoring virtual object in the game scene, and displaying a first monitoring area corresponding to the monitoring virtual object, includes:
in response to the trigger instruction for the monitoring game skill, obtaining skill information of the monitoring game skill;
generating the monitoring virtual object in the game scene according to the skill information, and displaying the first monitoring area corresponding to the monitoring virtual object.

In some embodiments, the skill information includes a skill state; and, generating the monitoring virtual object in the game scene according to the skill information, and displaying the first monitoring area corresponding to the monitoring virtual object, includes:
if the skill state of the monitoring game skill is a ready state, generating the monitoring virtual object in the game scene, and displaying the first monitoring area corresponding to the monitoring virtual object.

In some embodiments, the skill information includes a number of the monitoring virtual object placed; and, generating the monitoring virtual object in the game scene, and displaying the first monitoring area corresponding to the monitoring virtual object, includes:
if the number of the monitoring virtual object placed does not reach an upper limit, generating the monitoring virtual object in the game scene, and displaying the first monitoring area corresponding to the monitoring virtual object.

In some embodiments, generating the monitoring virtual object in the game scene, and displaying the first monitoring area corresponding to the monitoring virtual object, includes:
obtaining a character orientation and a current position of the first player character;
displaying, on the current position, a monitoring virtual object with the character orientation as a target orientation, and a first monitoring area corresponding to the target orientation.

In some embodiments, the game skill further includes a searching game skill, and the searching game skill corresponds to a searching virtual object; in response to a trigger instruction for the game skill, determining a target virtual object corresponding to the trigger instruction, and controlling the target virtual object to monitor a set monitoring area in the game scene so as to calibrate the second player character within the monitoring area, includes:
in response to a trigger instruction for the searching game skill, displaying a searching virtual object in the game scene, and determining a second monitoring area corresponding to the searching virtual object;
controlling the searching virtual object to search for the second player character in the game scene so as to calibrate the second player character within the second monitoring area.

In some embodiments, controlling the searching virtual object to search for the second player character in the game scene so as to calibrate the second player character within the second monitoring area, includes:
controlling the searching virtual object to search for the second player character in the game scene, and adding at least one of a calibration state or an index state to a second player character present in the second monitoring area, where the index state is used for performing an attack index on a second player character in the index state.

Among them, displaying calibration information of the second player character calibrated in the graphical user interface, includes:
if a second player character in the calibration state is detected, displaying a character identification corresponding to the second player character in the calibration state in the game scene, and/or, displaying a position identification corresponding to the second player character in the calibration state in a preset game map.

In some embodiments, in response to a trigger instruction for the searching game skill, displaying a searching virtual object in the game scene, and determining a second monitoring area corresponding to the searching virtual object, includes:
in response to a trigger instruction for the searching game skill, displaying a game map interface;
in response to a touch operation for the game map interface, determining a searching destination of the searching virtual object;
obtaining a current position of the player character;
determining a first target position corresponding to the current position in the game scene, displaying the searching virtual object at the first target position, and determining the second monitoring area corresponding to the searching virtual object.

Among them, controlling the searching virtual object to search for the second player character in the game scene so as to calibrate the second player character within the second monitoring area, includes:
controlling the searching virtual object to move from the first target position to the searching destination so as to calibrate the second player character within the second monitoring area.

In some embodiments, in response to a touch operation for the game map interface, determining a searching destination of the searching virtual object, includes:
in response to a touch operation for any position point of the game map interface, determining a common path-finding point corresponding to the touch operation, and taking a position corresponding to the common path-finding point in the game scene as the searching destination of the searching virtual object.

In some embodiments, the game map interface includes a monitoring position point associated with the monitoring virtual object; and, in response to a touch operation for the game map interface, determining a destination of the searching virtual object, includes:
in response to a touch operation for at least one monitoring position point, determining the searching destination of the searching virtual object.

In some embodiments, in response to a touch operation for at least one monitoring position point, determining the searching destination of the searching virtual object, includes:
in response to a touch operation for the first monitoring position point, taking a position corresponding to the first monitoring position point in the game scene as a transit position of the searching virtual object;
in response to a touch operation for a second monitoring position point, taking a position corresponding to the second monitoring position point in the game scene as the searching destination of the searching virtual object.

In some embodiments, in response to a touch operation for at least one monitoring position point, determining the searching destination of the searching virtual object, includes:
in response to a touch operation for the first monitoring position point, taking a position of the game scene corresponding to the first monitoring position point as a transit position of the searching virtual object;
in response to a touch operation for any position point of the game map interface, determining a common path-finding point corresponding to the touch operation, and taking a position corresponding to the common path-finding point in the game scene as the searching destination of the searching virtual object.

In some embodiments, in response to a touch operation for at least one monitoring position point, determining the searching destination of the searching virtual object, includes:
in response to a touch operation for a target monitoring position point, taking a position corresponding to the target monitoring position point in the game scene as the searching destination of the searching virtual object.

In some embodiments, controlling the searching virtual object to move from the first target position to the searching destination so as to calibrate the second player character within the second monitoring area, includes:
controlling the searching virtual object to move from the first target position to the transit position, and then move from the transit position to the searching destination so as to calibrate the second player character within the second monitoring area.

In some embodiments, controlling the searching virtual object to move from the first target position to the searching destination so as to calibrate the second player character within the second monitoring area, includes:
controlling the searching virtual object to move from the first target position to the searching destination with the second monitoring area as a scanning range, so as to calibrate the second player character within the scanning range;
or, controlling the searching virtual object to move from the first target position to the searching destination at a preset movement speed and with the second monitoring area as a scanning range, so as to calibrate the second player character within the scanning range.

In some embodiments, the steps further include:
if the searching virtual object arrives at the searching destination and the searching destination is a position corresponding to the monitoring position point, switching the monitoring virtual object to a monitoring reinforcement state in response to the first monitoring area of the monitoring virtual object overlapping with the second monitoring area of the searching virtual object;
adding at least one of a calibration state or an index state to a second player character present in the first monitoring area within a duration of the monitoring reinforcement state of the monitoring virtual object.

In some embodiments, the steps further include:
if the searching virtual object arrives at the searching destination and the searching destination is the position corresponding to the monitoring position point, increasing the second monitoring area of the searching virtual object, and controlling the searching virtual object to destruct after staying on the monitoring virtual object corresponding to the monitoring position point for a preset duration.

In some embodiments, the steps further include:
if the searching virtual object arrives at the searching destination and the searching destination is a position corresponding to a common path-finding point, controlling the searching virtual object to destruct after staying at the searching destination for a preset duration.

In some embodiments, the steps further include:
in a process of searching in the game scene by the searching virtual object, if the first monitoring area of the monitoring virtual object overlaps with the second monitoring area of the searching virtual object, switching the monitoring virtual object to a monitoring reinforcement state;
adding at least one of a calibration state or an index state to a second player character present in the first monitoring area within a duration of the monitoring reinforcement state of the monitoring virtual object.

In some embodiments, the steps further include:
obtaining position information of the searching virtual object, and displaying a movement identification corresponding to the searching virtual object in a game map interface displayed on the graphical user interface according to the position information;
sending the position information to a second terminal device corresponding to the second player character, where the second terminal device is configured to display the movement identification corresponding to the searching virtual object in the game map interface displayed on the graphical user interface.

In some embodiments, the game skill includes an attacking game skill, the attacking game skill corresponds to a close virtual object, and the method further includes:
in response to a trigger instruction for the attacking game skill, determining a second player character, and controlling the close virtual object to perform an attacking operation for the second player character.

In some embodiments, in response to a trigger instruction for the attacking game skill, determining a second player character, and controlling the close virtual object to perform an attacking operation for the second player character, includes:
if a second player character is present within a target range of the first player character, triggering the attacking game skill;
controlling the close virtual object to perform the attacking operation for the second player character.

In some embodiments, in response to detecting that a second player character is present within a target range of the first player character, triggering the attacking game skill, includes:
in response to detecting that a second player character in the index state and/or a second player character in the calibration state is present within the target range of the first player character, triggering the attacking game skill.

In some embodiments, before, in response to detecting that a second player character is present within a target range of the first player character, triggering the attacking game skill, the method further includes:
obtaining a relative distance between the first player character and a second player character located in the game scene.

Among them, in response to detecting that a second player character in the index state and/or a second player character in the calibration state is present within the target range of the first player character, triggering the attacking game skill, includes:
determining a second player character in the index state and/or the calibration state in the game scene;
if the relative distance between the first player character and the second player character in the index state and/or the second player character in the calibration state is less than or equal to a preset distance threshold, triggering the attacking game skill.

In some embodiments, if a relative distance between the first player character and the second player character is less than or equal to a preset distance threshold, triggering the attacking game skill, includes:
if the relative distance between the first player character and the second player character in the index state is less than or equal to the preset distance threshold, and no obstacle is present between the first player character and the second player character in the index state, triggering the attacking game skill.

The specific embodiment content of running the method for controlling the virtual object in the embodiment is also applicable to the embodiment content of the foregoing method for controlling the virtual object, and therefore, details are not described here.

In the embodiments of the present disclosure, a graphical user interface is provided through an electronic terminal; the graphical user interface may include a game scene, a first player character located in the game scene, and a second player character in a different game camp from the first player character; among them, the first player character is configured with a plurality of game skills, and each game skill corresponds to a virtual object; in the game process, the player may release the corresponding target virtual object through the game skill, monitor the set monitoring area through the target virtual object, and calibrate the second player character in the monitoring area; and then, the terminal may display the calibration information of the second player character calibrated in the graphical user interface, so as to search, monitor, and calibrate the second player character in the game scene effectively through monitoring by the target virtual object. By displaying the calibration information in the game interface, the player can intuitively and quickly determine the orientation of the second player character, so as to make a reasonable game decision, thus reducing the time consuming of the round of game and reducing the overhead of the terminal.

The communication bus mentioned for the above terminal may be a peripheral component interconnect (PCI) bus or an extended industry standard architecture (EISA) bus, etc. The communication bus may be divided into an address bus, a data bus, a control bus, or the like. For ease of representation, only one thick line is used to represent in the drawing, but it does not mean that there is only one bus or one type of bus.

The communication interface is used for communication between the terminal and other devices.

The memory may include a random access memory (RAM), or may include a non-volatile memory, for example, at least one magnetic disk memory. In some embodiments, the memory may further be at least one storage device located away from the processor.

The above processor may be a general purpose processor, including a central processing unit (CPU), a network processor (NP), etc. Alternatively, it may be a digital signal processor (DSP), an application specific integrated circuit (ASIC), a field-programmable gate array (FPGA), or another programmable logic device, a discrete gate or a transistor logic device, a discrete hardware component.

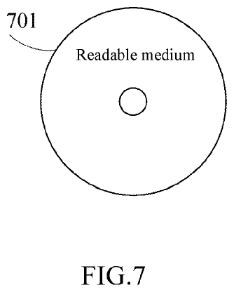

As shown in FIG. 7, according to yet another embodiment provided in the present disclosure, there is further provided a computer-readable storage medium 701. The computer-readable storage medium stores an instruction. When the instruction runs on a computer, the computer is enabled to implement the following steps:
in response to a trigger instruction for the game skill, determining a target virtual object corresponding to the trigger instruction, and controlling the target virtual object to monitor a set monitoring area in the game scene so as to calibrate the second player character within the monitoring area;
displaying calibration information of the second player character calibrated in the graphical user interface.

In some embodiments, the game skill includes a monitoring game skill, the monitoring game skill corresponds to a monitoring virtual object, and, in response to a trigger instruction for the game skill, determining a target virtual object corresponding to the trigger instruction, and controlling the target virtual object to monitor a set monitoring area in the game scene so as to calibrate the second player character within the monitoring area, includes:
in response to a trigger instruction for the monitoring game skill, generating a monitoring virtual object in the game scene, and displaying a first monitoring area corresponding to the monitoring virtual object;
controlling the monitoring virtual object to monitor the first monitoring area so as to calibrate the second player character within the first monitoring area.

In some embodiments, controlling the monitoring virtual object to monitor the first monitoring area so as to calibrate the second player character within the first monitoring area includes:
controlling the monitoring virtual object to monitor the first monitoring area; if a second player character in the target state is present in the first monitoring area, adding at least one of a calibration state or an index state to the second player character in the target state, where the index state is a state in which the second player character is able to be identified and attacked.

Among them, displaying calibration information of the second player character calibrated in the graphical user interface includes:
if a second player character in the calibration state is detected, displaying a character identification corresponding to the second player character in the calibration state in the game scene, and/or, displaying a position identification corresponding to the second player character in the calibration state in a preset game map.

In some embodiments, the target state includes at least one of a running movement state, a crouching state, a camouflage error state, and a skill release state.

In some embodiments, in response to a trigger instruction for the monitoring game skill, generating a monitoring virtual object in the game scene, and displaying a first monitoring area corresponding to the monitoring virtual object, includes:
in response to the trigger instruction for the monitoring game skill, obtaining skill information of the monitoring game skill;
generating the monitoring virtual object in the game scene according to the skill information, and displaying the first monitoring area corresponding to the monitoring virtual object.

In some embodiments, the skill information includes a skill state; and, generating the monitoring virtual object in the game scene according to the skill information, and displaying the first monitoring area corresponding to the monitoring virtual object, includes:
if the skill state of the monitoring game skill is a ready state, generating the monitoring virtual object in the game scene, and displaying the first monitoring area corresponding to the monitoring virtual object.

In some embodiments, the skill information includes a number of the monitoring virtual object placed; and, generating the monitoring virtual object in the game scene, and displaying the first monitoring area corresponding to the monitoring virtual object, includes:
if the number of the monitoring virtual object placed does not reach an upper limit, generating the monitoring virtual object in the game scene, and displaying the first monitoring area corresponding to the monitoring virtual object.

In some embodiments, generating the monitoring virtual object in the game scene, and displaying the first monitoring area corresponding to the monitoring virtual object, includes:
obtaining a character orientation and a current position of the first player character;
displaying, on the current position, a monitoring virtual object with the character orientation as a target orientation, and a first monitoring area corresponding to the target orientation.

In some embodiments, the game skill further includes a searching game skill, and the searching game skill corresponds to a searching virtual object; in response to a trigger instruction for the game skill, determining a target virtual object corresponding to the trigger instruction, and controlling the target virtual object to monitor a set monitoring area in the game scene so as to calibrate the second player character within the monitoring area, includes:
in response to a trigger instruction for the searching game skill, displaying a searching virtual object in the game scene, and determining a second monitoring area corresponding to the searching virtual object;
controlling the searching virtual object to search for the second player character in the game scene so as to calibrate the second player character within the second monitoring area.

In some embodiments, controlling the searching virtual object to search for the second player character in the game scene so as to calibrate the second player character within the second monitoring area, includes:
controlling the searching virtual object to search for the second player character in the game scene, and adding at least one of a calibration state or an index state to a second player character present in the second monitoring area, where the index state is used for performing an attack index on a second player character in the index state.

Among them, displaying calibration information of the second player character calibrated in the graphical user interface, includes:
if a second player character in the calibration state is detected, displaying a character identification corresponding to the second player character in the calibration state in the game scene, and/or, displaying a position identification corresponding to the second player character in the calibration state in a preset game map.

In some embodiments, in response to a trigger instruction for the searching game skill, displaying a searching virtual object in the game scene, and determining a second monitoring area corresponding to the searching virtual object, includes:
in response to a trigger instruction for the searching game skill, displaying a game map interface;
in response to a touch operation for the game map interface, determining a searching destination of the searching virtual object;
obtaining a current position of the player character;
determining a first target position corresponding to the current position in the game scene, displaying the searching virtual object at the first target position, and determining the second monitoring area corresponding to the searching virtual object.

Among them, controlling the searching virtual object to search for the second player character in the game scene so as to calibrate the second player character within the second monitoring area, includes:
controlling the searching virtual object to move from the first target position to the searching destination so as to calibrate the second player character within the second monitoring area.

In some embodiments, in response to a touch operation for the game map interface, determining a searching destination of the searching virtual object, includes:
in response to a touch operation for any position point of the game map interface, determining a common path-finding point corresponding to the touch operation, and taking a position corresponding to the common path-finding point in the game scene as the searching destination of the searching virtual object.

In some embodiments, the game map interface includes a monitoring position point associated with the monitoring virtual object; and, in response to a touch operation for the game map interface, determining a destination of the searching virtual object, includes:
in response to a touch operation for at least one monitoring position point, determining the searching destination of the searching virtual object.

In some embodiments, in response to a touch operation for at least one monitoring position point, determining the searching destination of the searching virtual object, includes:
in response to a touch operation for the first monitoring position point, taking a position corresponding to the first monitoring position point in the game scene as a transit position of the searching virtual object;
in response to a touch operation for a second monitoring position point, taking a position corresponding to the second monitoring position point in the game scene as the searching destination of the searching virtual object.

In some embodiments, in response to a touch operation for at least one monitoring position point, determining the searching destination of the searching virtual object, includes:
in response to a touch operation for the first monitoring position point, taking a position of the game scene corresponding to the first monitoring position point as a transit position of the searching virtual object;
in response to a touch operation for any position point of the game map interface, determining a common path-finding point corresponding to the touch operation, and taking a position corresponding to the common path-finding point in the game scene as the searching destination of the searching virtual object.

In some embodiments, in response to a touch operation for at least one monitoring position point, determining the searching destination of the searching virtual object, includes:
in response to a touch operation for a target monitoring position point, taking a position corresponding to the target monitoring position point in the game scene as the searching destination of the searching virtual object.

In some embodiments, controlling the searching virtual object to move from the first target position to the searching destination so as to calibrate the second player character within the second monitoring area, includes:
controlling the searching virtual object to move from the first target position to the transit position, and then move from the transit position to the searching destination so as to calibrate the second player character within the second monitoring area.

In some embodiments, controlling the searching virtual object to move from the first target position to the searching destination so as to calibrate the second player character within the second monitoring area, includes:
controlling the searching virtual object to move from the first target position to the searching destination with the second monitoring area as a scanning range, so as to calibrate the second player character within the scanning range;
or, controlling the searching virtual object to move from the first target position to the searching destination at a preset movement speed and with the second monitoring area as a scanning range, so as to calibrate the second player character within the scanning range.

In some embodiments, the steps further include:
if the searching virtual object arrives at the searching destination and the searching destination is a position corresponding to the monitoring position point, switching the monitoring virtual object to a monitoring reinforcement state in response to the first monitoring area of the monitoring virtual object overlapping with the second monitoring area of the searching virtual object;
adding at least one of a calibration state or an index state to a second player character present in the first monitoring area within a duration of the monitoring reinforcement state of the monitoring virtual object.

In some embodiments, the steps further include:
if the searching virtual object arrives at the searching destination and the searching destination is the position corresponding to the monitoring position point, increasing the second monitoring area of the searching virtual object, and controlling the searching virtual object to destruct after staying on the monitoring virtual object corresponding to the monitoring position point for a preset duration.

In some embodiments, the steps further include:
if the searching virtual object arrives at the searching destination and the searching destination is a position corresponding to a common path-finding point, controlling the searching virtual object to destruct after staying at the searching destination for a preset duration.

In some embodiments, the steps further include:
in a process of searching in the game scene by the searching virtual object, if the first monitoring area of the monitoring virtual object overlaps with the second monitoring area of the searching virtual object, switching the monitoring virtual object to a monitoring reinforcement state;
adding at least one of a calibration state or an index state to a second player character present in the first monitoring area within a duration of the monitoring reinforcement state of the monitoring virtual object.

In some embodiments, the steps further include:
obtaining position information of the searching virtual object, and displaying a movement identification corresponding to the searching virtual object in a game map interface displayed on the graphical user interface according to the position information;
sending the position information to a second terminal device corresponding to the second player character, where the second terminal device is configured to display the movement identification corresponding to the searching virtual object in the game map interface displayed on the graphical user interface.

In some embodiments, the game skill includes an attacking game skill, the attacking game skill corresponds to a close virtual object, and the method further includes:
in response to a trigger instruction for the attacking game skill, determining a second player character, and controlling the close virtual object to perform an attacking operation for the second player character.

In some embodiments, in response to a trigger instruction for the attacking game skill, determining a second player character, and controlling the close virtual object to perform an attacking operation for the second player character, includes:
if a second player character is present within a target range of the first player character, triggering the attacking game skill;
controlling the close virtual object to perform the attacking operation for the second player character.

In some embodiments, in response to detecting that a second player character is present within a target range of the first player character, triggering the attacking game skill, includes:
in response to detecting that a second player character in the index state and/or a second player character in the calibration state is present within the target range of the first player character, triggering the attacking game skill.

In some embodiments, before, in response to detecting that a second player character is present within a target range of the first player character, triggering the attacking game skill, the method further includes:
obtaining a relative distance between the first player character and a second player character located in the game scene.

Among them, in response to detecting that a second player character in the index state and/or a second player character in the calibration state is present within the target range of the first player character, triggering the attacking game skill, includes:
determining a second player character in the index state and/or the calibration state in the game scene;
if the relative distance between the first player character and the second player character in the index state and/or the second player character in the calibration state is less than or equal to a preset distance threshold, triggering the attacking game skill.

In some embodiments, if a relative distance between the first player character and the second player character is less than or equal to a preset distance threshold, triggering the attacking game skill, includes:
if the relative distance between the first player character and the second player character in the index state is less than or equal to the preset distance threshold, and no obstacle is present between the first player character and the second player character in the index state, triggering the attacking game skill.

The specific embodiment content of running the method for controlling the virtual object in the embodiment is also applicable to the embodiment content of the foregoing method for controlling the virtual object, and therefore, details are not described here.

In the embodiments of the present disclosure, a graphical user interface is provided through an electronic terminal; the graphical user interface may include a game scene, a first player character located in the game scene, and a second player character in a different game camp from the first player character; among them, the first player character is configured with a plurality of game skills, and each game skill corresponds to a virtual object; in the game process, the player may release the corresponding target virtual object through the game skill, monitor the set monitoring area through the target virtual object, and calibrate the second player character in the monitoring area; and then, the terminal may display the calibration information of the second player character calibrated in the graphical user interface, so as to search, monitor, and calibrate the second player character in the game scene effectively through monitoring by the target virtual object. By displaying the calibration information in the game interface, the player can intuitively and quickly determine the orientation of the second player character, so as to make a reasonable game decision, thus reducing the time consuming of the round of game and reducing the overhead of the terminal.

According to yet another embodiment of the present disclosure, there is further provided a computer program product including an instruction. When the computer program product runs on a computer, the computer is enabled to perform the method for controlling the virtual object in the foregoing embodiments.

The above embodiments may be all or partially implemented by software, hardware, firmware, or any combination of them. When implemented using software, they may be all or partially implemented in the form of a computer program product. The computer program product includes one or more computer instructions. When the computer program instruction is loaded and executed on a computer, the processes or functions according to the embodiments of the present disclosure are all or partially generated. The computer may be a general purpose computer, a special purpose computer, a computer network, or another programmable apparatus. The computer instruction may be stored in a computer-readable storage medium or transmitted from one computer-readable storage medium to another computer-readable storage medium. For example, the computer instructions may be transmitted from a website site, computer, server, or data center to another website site, computer, server, or data center in a wired manner (e.g., coaxial cable, optical fiber, digital subscriber line (DSL)) or a wireless manner (e.g., infrared, wireless, microwave, etc.). The computer-readable storage medium may be any available medium accessible by a computer, or a data storage device such as a server or a data center integrated with one or more available medium. The available medium may be a magnetic medium (e.g., a floppy disk, a hard disk, or a magnetic tape), an optical medium (e.g., a DVD), or a semiconductor medium (e.g., a solid state disk (SSD)), etc.

It should be noted that, in the context, relational terms, such as “first” and “second”, are merely used to distinguish one entity or operation from another entity or operation, and do not necessarily require or imply that there is such actual relationship or order among them these entities or operations. Moreover, the term “comprising”, “including”, or any other variant of them is intended to cover a non-exclusive inclusion, such that a process, method, article, or device that includes a series of elements includes not only those elements, but also other elements not explicitly listed, or elements inherent to such a process, method, article, or device. In the absence of more restrictions, the element defined by the statement “including a . . . ” does not exclude the presence of additional identical elements in the process, method, article, or device that includes the element.

Various embodiments in the present specification are described in a related manner, the same or similar parts between the various embodiments can refer to each other, and each embodiment focuses on the difference from other embodiments. In particular, for the system embodiment, since it is basically similar to the method embodiment, the description is relatively simple, and the related part may refer to the part of description of the method embodiment.

The foregoing is merely preferred embodiments of the present disclosure and is not intended to limit the protection scope of the present disclosure. Any modification, equivalent replacement, improvement, etc., made within the spirit and principle of the present disclosure are included within the protection scope of the present disclosure.

1. A method for controlling a virtual object, comprising:
determining, in response to a trigger instruction for a game skill of a first player character located in a game scene, a target virtual object corresponding to the trigger instruction, and controlling the target virtual object to monitor a monitoring area in the game scene to locate a second player character within the monitoring area; wherein a graphical user interface is provided through a first electronic terminal, and contents displayed by the graphical user interface comprise at least a part of the game scene and the first player character; wherein the game scene further comprises the second player character in a different game camp from the first player character, the first player character is configured with a plurality of game skills, each game skill corresponds to a virtual object; and
displaying calibration information of the second player character located in the graphical user interface, wherein the calibration information of the second player character comprises at least one of a character identification corresponding to the second player character or a position identification corresponding to the second player character.

2. The method according to claim 1, wherein the game skill comprises a monitoring game skill, and the monitoring game skill corresponds to a monitoring virtual object; and wherein determining the target virtual object corresponding to the trigger instruction, and controlling the target virtual object to monitor the set monitoring area in the game scene, comprises:
generating, in response to a trigger instruction for the monitoring game skill, a monitoring virtual object in the game scene, and displaying a first monitoring area corresponding to the monitoring virtual object; and
controlling the monitoring virtual object to monitor the first monitoring area to locate the second player character within the first monitoring area.

3. The method according to claim 2, wherein controlling the monitoring virtual object to monitor the first monitoring area to locate the second player character within the first monitoring area, comprises:
controlling the monitoring virtual object to monitor the first monitoring area; and, in response to determining that a second player character in a target state is present in the first monitoring area, adding at least one of a calibration state or an index state to the second player character in the target state, wherein the index state is a state in which the second player character is able to be identified and attacked;
wherein displaying calibration information of the second player character located in the graphical user interface, comprises at least one of:
displaying, in response to detecting a second player character in the calibration state, a character identification corresponding to the second player character in the calibration state in the game scene; or
displaying a position identification corresponding to the second player character in the calibration state in a preset game map;
wherein the target state comprises at least one of a running movement state, a crouching state, a camouflage error state, or a skill release state.

4. (canceled)

5. The method according to claim 2, wherein generating the monitoring virtual object in the game scene, and displaying the first monitoring area corresponding to the monitoring virtual object, comprises:
obtaining, in response to the trigger instruction for the monitoring game skill, skill information of the monitoring game skill; and
generating the monitoring virtual object in the game scene according to the skill information, and displaying the first monitoring area corresponding to the monitoring virtual object.

6. The method according to claim 5, wherein the skill information comprises a skill state; and wherein generating the monitoring virtual object in the game scene according to the skill information, and displaying the first monitoring area corresponding to the monitoring virtual object, comprises:
generating, in response to determining that the skill state of the monitoring game skill is a ready state, the monitoring virtual object in the game scene, and displaying the first monitoring area corresponding to the monitoring virtual object.

7. The method according to claim 6, wherein generating the monitoring virtual object in the game scene, and displaying the first monitoring area corresponding to the monitoring virtual object, comprises at least one of:
generating, in response to determining that a number of the monitoring virtual object placed does not reach an upper limit, the monitoring virtual object in the game scene, and displaying the first monitoring area corresponding to the monitoring virtual object; wherein the skill information comprises the number of the monitoring virtual object placed; or
obtaining a character orientation and a current position of the first player character; and, displaying, on the current position, a monitoring virtual object with the character orientation as a target orientation and a first monitoring area corresponding to the target orientation.

8. (canceled)

9. The method according to claim 2, wherein the game skill further comprises a searching game skill, and the searching game skill corresponds to a searching virtual object; and wherein determining the target virtual object corresponding to the trigger instruction, and controlling the target virtual object to monitor the monitoring area in the game scene, comprises:
displaying, in response to a trigger instruction for the searching game skill, a searching virtual object in the game scene, and determining a second monitoring area corresponding to the searching virtual object; and
controlling the searching virtual object to search for the second player character in the game scene to locate the second player character within the second monitoring area.

10. The method according to claim 9, wherein controlling the searching virtual object to search for the second player character in the game scene to locate the second player character within the second monitoring area, comprises:
controlling the searching virtual object to search for the second player character in the game scene, and adding at least one of a calibration state or an index state to a second player character present in the second monitoring area, wherein the index state is used for performing an attack index on a second player character in the index state;
wherein displaying calibration information of the second player character located in the graphical user interface, comprises at least one of:
displaying, in response to detecting a second player character in the calibration state, a character identification corresponding to the second player character in the calibration state in the game scene; or
displaying a position identification corresponding to the second player character in the calibration state in a preset game map.

11. The method according to claim 9, wherein displaying the searching virtual object in the game scene, and determining the second monitoring area corresponding to the searching virtual object, comprises:
displaying, in response to the trigger instruction for the searching game skill, a game map interface;
determining, in response to a touch operation for the game map interface, a searching destination of the searching virtual object;
obtaining a current position of the player character; and
determining a first target position corresponding to the current position in the game scene, displaying the searching virtual object at the first target position, and determining the second monitoring area corresponding to the searching virtual object;
wherein controlling the searching virtual object to search for the second player character in the game scene to locate the second player character within the second monitoring area, comprises:
controlling the searching virtual object to move from the first target position to the searching destination to locate the second player character within the second monitoring area.

12. The method according to claim 11, wherein determining the searching destination of the searching virtual object, comprises at least one of:
determining, in response to a touch operation for any position point of the game map interface, a common path-finding point corresponding to the touch operation, and taking a position corresponding to the common path-finding point in the game scene as the searching destination of the searching virtual object; or
determining, in response to a touch operation for at least one monitoring position point, the searching destination of the searching virtual object, wherein the game map interface comprises a monitoring position point associated with the monitoring virtual object.

13. (canceled)

14. The method according to claim 12, wherein, determining the searching destination of the searching virtual object, comprises at least one of:
taking, in response to a touch operation for a first monitoring position point, a position corresponding to the first monitoring position point in the game scene as a transit position of the searching virtual object; and taking, in response to a touch operation for a second monitoring position point, a position corresponding to the second monitoring position point in the game scene as the searching destination of the searching virtual object; or
taking, in response to a touch operation for a first monitoring position point, a position of the game scene corresponding to the first monitoring position point as a transit position of the searching virtual object; and determining, in response to a touch operation for any position point of the game map interface, a common path-finding point corresponding to the touch operation, and taking a position corresponding to the common path-finding point in the game scene as the searching destination of the searching virtual object; or
taking, in response to a touch operation for a target monitoring position point, a position corresponding to the target monitoring position point in the game scene as the searching destination of the searching virtual object.

15. (canceled)

16. (canceled)

17. The method according to claim 14, wherein controlling the searching virtual object to move from the first target position to the searching destination to locate the second player character within the second monitoring area, comprises:
controlling the searching virtual object to move from the first target position to the transit position, and then move from the transit position to the searching destination to locate the second player character within the second monitoring area.

18. The method according to claim 11, wherein controlling the searching virtual object to move from the first target position to the searching destination to locate the second player character within the second monitoring area, comprises at least one of:
controlling the searching virtual object to move from the first target position to the searching destination with the second monitoring area as a scanning range to locate the second player character within the scanning range: or
controlling the searching virtual object to move from the first target position to the searching destination at a preset movement speed and with the second monitoring area as a scanning range to locate the second player character within the scanning range.

19. The method according to claim 11, further comprising:
switching, in response to determining that the searching virtual object arrives at the searching destination and the searching destination is a position corresponding to the monitoring position point, the monitoring virtual object to a monitoring reinforcement state in response to the first monitoring area of the monitoring virtual object overlapping with the second monitoring area of the searching virtual object;
adding at least one of a calibration state or an index state to a second player character present in the first monitoring area within a duration of the monitoring reinforcement state of the monitoring virtual object; and
increasing, in response to determining that the searching virtual object arrives at the searching destination and the searching destination is a position corresponding to the monitoring position point, the second monitoring area of the searching virtual object, and controlling the searching virtual object to destruct after staying on the monitoring virtual object corresponding to the monitoring position point for a preset duration.

20. (canceled)

21. The method according to claim 12, further comprising:
controlling, in response to determining that the searching virtual object arrives at the searching destination and the searching destination is a position corresponding to a common path-finding point, the searching virtual object to destruct after staying at the searching destination for a preset duration.

22. The method according to claim 9, further comprising at least one of:
switching, in a process of searching in the game scene by the searching virtual object, the monitoring virtual object to a monitoring reinforcement state in response to determining that the first monitoring area of the monitoring virtual object overlaps with the second monitoring area of the searching virtual object; and, adding at least one of a calibration state or an index state to a second player character present in the first monitoring area within a duration of the monitoring reinforcement state of the monitoring virtual object; or
obtaining position information of the searching virtual object, and displaying a movement identification corresponding to the searching virtual object in a game map interface displayed on the graphical user interface according to the position information; and, sending the position information to a second terminal device corresponding to the second player character, wherein the second terminal device is configured to display the movement identification corresponding to the searching virtual object in the game map interface displayed on the graphical user interface.

23. (canceled)

24. The method according to claim 3, wherein the game skill comprises an attacking game skill, the attacking game skill corresponds to a close virtual object, and the method further comprises:
determining, in response to a trigger instruction for the attacking game skill, a second player character, and controlling the close virtual object to perform an attacking operation for the second player character;
wherein determining the second player character, and controlling the close virtual object to perform the attacking operation for the second player character, comprises:
triggering, in response to determining that a second player character is present within a target range of the first player character, the attacking game skill; and
controlling the close virtual object to perform the attacking operation for the second player character.

25. (canceled)

26. The method according to claim 24, wherein triggering the attacking game skill, comprises:
triggering, in response to detecting that a second player character in the index state and/or a second player character in the calibration state is present within the target range of the first player character, the attacking game skill.

27. The method according to claim 26, further comprising:
obtaining a relative distance between the first player character and a second player character located in the game scene;
wherein, triggering, in response to detecting that a second player character in the index state and/or a second player character in the calibration state is present within the target range of the first player character, the attacking game skill, comprises:
determining a second player character in the index state and/or the calibration state in the game scene; and
triggering, in response to determining that the relative distance between the first player character and the second player character in the index state and/or the second player character in the calibration state is less than or equal to the preset distance threshold, the attacking game skill.

28. The method according to claim 27, wherein triggering, in response to determining that the relative distance between the first player character and the second player character is less than or equal to a preset distance threshold, the attacking game skill, comprises:
triggering the attacking game skill, in response to determining that the relative distance between the first player character and the second player character in the index state is less than or equal to the preset distance threshold, and no obstacle is present between the first player character and the second player character in the index state.

29. (canceled)

30. (canceled)
